(19) United States
(12) Patent Application Publication
(10) Pub. No.: US 2024/0151916 A1
(43) Pub. Date: May 9, 2024

(54) MICROSCALE MULTI-FUNCTIONAL OPTICAL STRUCTURE

(71) Applicant: LESSENGERS Inc., Pohang-si (KR)

(72) Inventors: Chongcook KIM, Seoul (KR); Taeyong KIM, Gyeonggi-do (KR); Manjae KIM, Gyeongsangbuk-do (KR)

(73) Assignee: LESSENGERS Inc., Pohang-si (KR)

(21) Appl. No.: 18/131,376

(22) Filed: Apr. 6, 2023

(30) Foreign Application Priority Data
Nov. 8, 2022 (KR) 10-2022-0148052

(51) Int. Cl. G02B 6/42

(52) U.S. Cl. CPC G02B 6/4206; G02B 6/4274

(57) ABSTRACT

A microscale multi-functional optical structure is disclosed.

Embodiments of the present disclosure provide a microscale multi-functional optical structure including: a substrate; a first layer formed on the substrate; a multi-functional optical function unit formed using a second layer formed on the first layer to provide various optical functions with the substrate and the first layer; and at least one optical coupling wire formed to include a wire end portion formed to come into close contact with a preset region on the second layer to transmit and receive an optical signal to and from an optical waveguide.

### RELATED APPLICATION

This application claims the benefit of priority of Republic of Korea Patent Application No. 10-2022-0148052 filed on Nov. 8, 2022, the contents of which are incorporated by reference as if fully set forth herein in their entirety.

### FIELD AND BACKGROUND OF THE INVENTION

Embodiments of the present disclosure relate to a microscale multi-functional optical structure.

Content described in this part only provides background information for the present disclosure and does not constitute the related art.

One of methods capable of efficiently processing sharply increasing traffic in a data center is a data center optical interconnect solution, that is, expansion of a data center optical module. An applicable region of the optical module is gradually widened according to development of optical communication technology and an increase in data traffic. The common goals of various standards adopted for optical connection solutions are high speed, high bandwidth, and high density of data.

According to the trend of the high speed, the high bandwidth, and the high density, since a technical difficulty and a burden due to adoption for the optical module are also increasing, and the optical module also occupies the second largest portion after a server in costs consumed to constitute the minimum unit data center, securing and innovating a technology for mass production of optical modules are very urgent.

There is a small removable module such as a quad small form-factor pluggable (QSFP) module or a QSFP double density (QSFP-DD)/octal small form-factor pluggable (OSFP) module which is the most popularly used type among physical interfaces adopted in a data center. This removable module is used in a short-range data center connection cable, and is also used in an optical module for transmitting and receiving a long-range optical signal at a distance of tens of kilometers away.

A data center optical module specified as an optical transceiver is classified into a short range (SR), a DR, an FR, a long range (LR), or the like according to an optical signal transmission distance (reach), a physical medium dependent (PMD) type, and the like, transmits and receives an electrical signal with a host device such as a switch/server or the like, and transmits and receives an optical signal with an optical module at the opposite side connected thereto through an optical cable.

Assuming a case of a common optical module composed of 4 channels, each of an SR4 and a DR4 requires eight multi-mode fibers and single-mode fibers, wherein four fibers are used for transmission and the remaining four fibers are used for reception. On the other hand, each of an FR4 and an LR4 includes two single-mode optical fibers and uses one for each of the transmission and the reception. This is possible as FR4 and LR4 standards adopt a wavelength division multiplexing (WDM) technology.

When the wavelength division multiplexing technology is used, there is an advantage in that the number of optical fibers used for data transmission can be dramatically reduced, but since several optical signals having different wavelengths should be input to one optical fiber, an additional component called an optical signal multiplexer or a demultiplexer is required. Accordingly, the wavelength division multiplexing technology is a technology suitable for constituting a long and medium-range optical communication network rather than a short-range optical communication network in which optical fibers occupy a low proportion in the costs for constituting an entire optical link.

There are an arrayed waveguide grating (AWG) type and a bandpass filter type as an optical signal multiplexer and a demultiplexer mainly used in an optical module for a data center.

In the case of the AWG-type multiplexer and demultiplexer, sizes are changed according to wavelengths and the number of optical signals for division or coupling, and the material which implements the AWG type. Commonly, in the AWG type multiplexer and demultiplexer used in the optical module for a data center, the sizes range from several mm to several tens of mm.

In the case of the bandpass filter type multiplexer and demultiplexer, thin film type bandpass filters as many as the wavelengths and the number of optical signals for division or coupling are required, and a space which supports and accommodates other optical elements and optical components is required, and in addition, an additional structure for optical alignment/optical coupling with the optical elements and optical components is required.

Furthermore, in the case of an advanced data center optical module essentially using signal processing semiconductor elements such as a clock and data recovery (CDR) circuit, a digital signal processor (DSP), and the like, and including complicated optical components and electronic components, an additional heat dissipation structure for thermal management is required in addition to a space for these signal processing semiconductor elements.

Accordingly, a microscale multi-functional optical structure capable of performing optical coupling, optical distribution, and wavelength division applicable to a highly integrated micro-optical module suitable for mass production due to a simple manufacturing process while satisfying performance required in various implementation agreements and standards, and an optical module applying the same are required.

### SUMMARY OF THE INVENTION

Embodiments of the present disclosure are directed to providing a microscale multi-functional optical structure capable of performing optical coupling, optical distribution, and wavelength division capable of acquiring high optical signal integrity while achieving high speed, high bandwidth, and high density.

Also, embodiments of the present disclosure are directed to providing a microscale multi-functional optical structure of which mass production is possible in a completely manual alignment method which allows high productivity and high yield to be achieved at the same time without using expensive precision equipment or a measuring instrument.

According to one aspect of embodiments of the present disclosure, provided is a microscale multi-functional optical structure including: a substrate; a first layer formed on the substrate; a multi-functional optical function unit formed using a second layer formed on the first layer to provide various optical functions with the substrate and the first layer; and at least one optical coupling wire formed to include a wire end portion formed to come into close contact with a preset region on the second layer to transmit and receive an optical signal to and from an optical waveguide.

### BRIEF DESCRIPTION OF THE SEVERAL VIEWS OF THE DRAWINGS

FIG. 1 illustrates a microscale multi-functional optical structure according to one embodiment of the present disclosure;

FIG. 2 illustrates a microscale multi-functional optical structure which performs a function of an optical coupler or an optical distributor according to one embodiment of the present disclosure;

FIG. 3 illustrates a microscale multi-functional optical structure which performs a wavelength division function according to one embodiment of the present disclosure;

FIG. 4 illustrates a microscale multi-functional optical structure which performs wavelength division and reverse wavelength division functions according to one embodiment of the present disclosure; and

FIG. 5 is a conceptual diagram of an optical module including a microscale multi-functional optical structure according to one embodiment of the present disclosure.

### EFFECTS OF THE INVENTION

According to one embodiment of the present disclosure, there is an effect in that a micro-sized and multi-channel microscale multi-functional optical structure capable of performing functions of optical coupling, optical distribution, and wavelength division can be provided.

According to another aspect of one embodiment of the present disclosure, there is an effect in that a micro-sized and multi-channel microscale multi-functional optical structure of which high speed, high bandwidth, and high density are possible can be mass-produced with high productivity and high yield without using expensive precision equipment or a measuring instrument.

The above description is only an exemplary description of the technical spirit of the various embodiments of the present disclosure, and various changes and modifications are possible by those skilled in the art without departing from essential characteristics of the embodiments. Accordingly, the embodiments are provided not to limit but to describe the technical spirit of the embodiments, and the scope of the technical spirit of the embodiments is not limited by these embodiments. The scope of the embodiments should be interpreted by the claims to be described below, and it should be interpreted that all technical spirit within the equivalent range are included in the scope of the embodiments.

### DESCRIPTION OF SPECIFIC EMBODIMENTS OF THE INVENTION

Hereinafter, microscale multi-functional optical structures according to embodiments of the present disclosure will be described in detail with reference to the accompanying drawings. In the following drawings, the same reference numerals refer to the same components, and in the drawings, the size of each component may be exaggerated for clarity and convenience of the description.

Further, embodiments to be described below are only exemplary, and various modifications are possible from these embodiments. Hereinafter, the term disclosed as “on” or “above” may include not only “directly on” with contact but also “on” without contact.

A singular form also includes a plural form, unless the context clearly indicates otherwise. Further, a case in which a part “includes” a certain component refers to a case in which other components may be further included, rather than excluding other components, unless otherwise disclosed.

Use of the term “the” and similar indicating terms may correspond to both the singular form and the plural form. When there is no explicit disclosure of an order or an opposite disclosure for operations constituting a method, these operations may be performed in any suitable order, and are not necessarily limited to the disclosed order.

Further, a term such as “unit”, “member”, “member”, “module”, or the like disclosed in the specification refer to a unit which processes at least one function or operation, and this may be implemented as hardware or software, or a combination of hardware and software.

Further, connection or connection members of lines between components shown in the drawings exemplarily represent functional connections and/or physical or circuit connections, and in an actual device, may be referred to as various functional connections, physical connections, or circuit connections which may be replaced or added.

Use of all examples or exemplary terms is simply provided to describe technical ideas in detail, and the scope is not limited by these examples or exemplary terms unless limited by the claims.

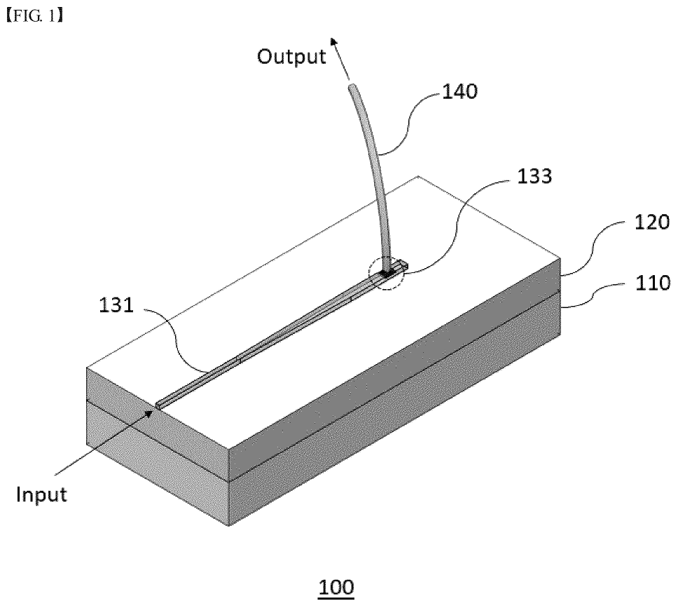

FIG. 1 illustrates a microscale multi-functional optical structure according to one embodiment of the present disclosure.

Referring to FIG. 1, a microscale multi-functional optical structure 100 according to one embodiment of the present disclosure includes a substrate 110, a first layer 120, a second layer 130, and an optical coupling wire 140. The microscale multi-functional optical structure 100 is designed so that an optical signal input to an input unit Input of the microscale multi-functional optical structure 100 is output to an output unit Output according to a predetermined condition by combining the substrate 110, the first layer 120, and the second layer 130 which are formed to have materials different from each other or at least one material different from each other.

The substrate 110 supports various types of optical elements or electrical elements to help transmission and reception of the optical signal. The substrate 110 may be made of glass or synthetic resin having high light transmittance which is advantageous for transmitting and receiving an optical signal, and may be a printed circuit board (PCB) including at least one layer capable of transmitting and receiving an electrical signal. Further, the substrate 110 may be a photonic integrated circuit manufactured using a semiconductor capable of reflecting or absorbing an optical signal of a specific wavelength.

The substrate 110 may be formed of a flat and rigid material, but may be formed of a material which may be bent or curved for smooth arrangement in a three-dimensional space.

The substrate 110 may be formed of, for example, silicon (Si). However, the material of the substrate 110 is not necessarily limited to silicon, and various wafer materials used in a semiconductor manufacturing process may be used as the material of the substrate 110.

The first layer 120 includes a transparent insulating oxide. The first layer 120 may act as a lower clad for various types of optical elements disposed on the first layer 120, such as a light source, a photodetector, an optical modulator, an optical transmission/reception system, and an optical waveguide.

The first layer 120 may serve to prevent leakage of the optical signal to a lower portion of each of the light source, the photodetector, the optical modulator, the optical transmission/reception optical system, and the optical waveguide. A transparent insulating oxide material of the first layer 120 may be, for example, silicon oxide (SiO₂) or silicon nitride (SiₓN_{y}), but is not necessarily limited thereto.

The oxide material of the first layer 120 may be formed of any transparent material having a lower refractive index than a material used for the light source, the photodetector, the optical modulator, the optical transmission/reception optical system, or the optical waveguide. Here, being transparent means having permeability for a wavelength band input to the input unit of the microscale multi-functional optical structure 100.

The second layer 130 may be formed of the same material as the substrate 110, and is designed and manufactured to have various shapes through various semiconductor manufacturing processes to perform functions including coupling, distribution, or wavelength division of the optical signal. The second layer 130 may be portions 131 and 133 left through a removal process such as etching or the like after being formed through the semiconductor manufacturing process.

The portion 131 of the second layer 130 may function as an optical waveguide, and the other portion 133 of the second layer 130 may serve as an optical port 133, and may be a grating coupler of a grating structure formed at a preset period. The grating coupler may receive or transmit an optical signal of a preset condition. For example, the optical signal input to the input unit Input may escape to the outside by passing through the portion 131 of the second layer 130 which functions as the optical waveguide, and then meeting the grating coupler 133.

The substrate 110, the first layer 120, and the second layer 130 are partially or entirely combined to serve as a multi-functional optical function unit. The multi-functional optical function unit is formed by including at least one optical signal input unit and at least one optical signal output unit.

The optical coupling wire 140 includes a wire end portion (not shown) which comes into close contact with a preset region of the second layer 130. The optical coupling wire 140 is formed to cover, for example, a region where the grating coupler 133 is formed to accommodate the optical signal which escapes from the grating coupler 133 through the wire end portion, and transfer the optical signal to an opposite side Output of the wire end portion.

At least one of the at least one optical signal input unit and the at least one optical signal output unit may include the grating coupler, and is formed without interruption to come into close contact with the optical coupling wire to help smooth optical transmission between the optical signal input unit and the optical signal output unit.

FIG. 1 illustrates that a first optical coupling wire 140 performs a role of helping the optical signal to be output to the outside of the microscale multi-functional optical structure 100 by coming into close contact with the optical port 133. However, the first optical coupling wire 140 may also serve as an optical signal input unit which helps the optical signal to be input from the outside of the microscale multi-functional optical structure 100 to the inside of the microscale multi-functional optical structure 100 by coming into close contact with the optical port 133.

The first optical coupling wire 241 may be formed using a synthetic resin having high light transmittance and a refractive index similar to that of an optical fiber. The first optical coupling wire 241 is designed and formed in consideration of physical compatibility, mechanical compatibility, thermal compatibility, or optical compatibility with two different interfaces which come into contact with the first optical coupling wire 21 to provide high optical coupling efficiency with the optical port 133 or an optical element (not shown) optically coupled thereto. Here, the physical compatibility, the mechanical compatibility, or the thermal compatibility may include thermal expansion coefficients, adhesion, or roughness of two different materials forming two interfaces, and the optical compatibility includes reflection, refraction, absorption, or the like which occurs between two different materials forming two interfaces. In this case, the two different interfaces which come into contact with the first optical coupling wire 21 may be surfaces of the optical port 133 or surfaces of the optical element.

The first optical coupling wire 21 is a compound manufactured by mixing various materials, and may be formed of a homogeneous material, or may be formed to have a characteristic which discontinuously or gradually changes according to a preset process condition. For example, when the physical characteristics, mechanical characteristics, thermal characteristics, or optical characteristics of material forming the optical port 133 which comes into contact with one end of the first optical coupling wire 21 and a material forming the optical element which comes into contact with the other end of the first optical coupling wire 21 are different, a material of a portion of the first optical coupling wire 21 which comes into contact with the optical port 133 may be designed and formed to be matched with the physical characteristic, mechanical characteristic, thermal characteristic, or optical characteristic of the optical port 133, and a material of a portion of the first optical coupling wire 21 which comes into contact with the optical element may be designed and formed to be matched with the physical characteristic, mechanical characteristic, thermal characteristic, or optical characteristic of the optical element. In a middle portion of the first optical coupling wire 21, these physical characteristics, mechanical characteristics, thermal characteristics, or optical characteristics may be formed to have a characteristic corresponding to a middle of the characteristics of both ends while adjusting a content of the material.

The first optical coupling wire 21 is designed and formed so that the first optical coupling wire 21 itself serves as an optical waveguide core and the surrounding air is used as a cladding of the optical waveguide.

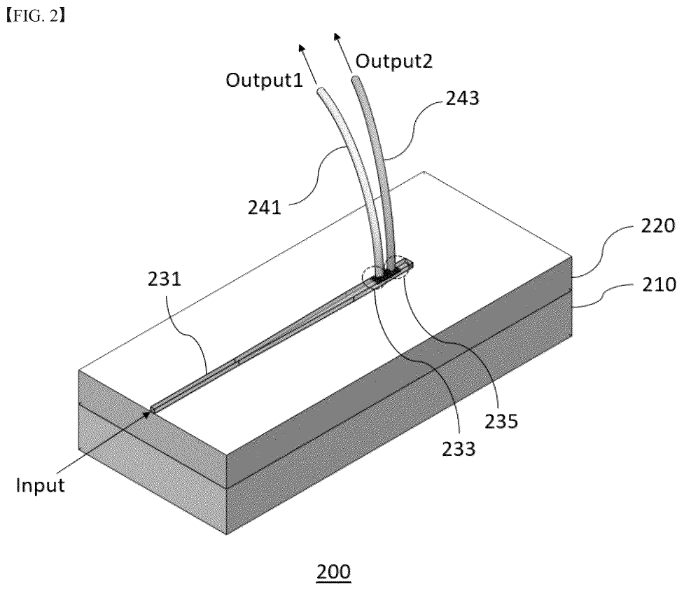

FIG. 2 illustrates a microscale multi-functional optical structure which performs a function of an optical coupler or an optical distributor according to one embodiment of the present disclosure.

Referring to FIG. 2, a microscale multi-functional optical structure 200 according to one embodiment of the present disclosure includes a substrate 210, a first layer 220, a second layer 230, and at least one optical coupling wire 241 or 243. The microscale multi-functional optical structure 200 is designed so that an optical signal input to an input unit Input2 of the microscale multi-functional optical structure 200 is output to an output unit Output21 or Output22 according to a predetermined condition by combining the substrate 210, the first layer 220, the second layer 230, and the at least one optical coupling wire 241 or 243 which are formed to have materials different from each other or at least one material different from each other. Here, the microscale multi-functional optical structure 200 may be an optical distributor.

The substrate 210, the first layer 220, the second layer 230, and the at least one optical coupling wire 241 or 243 respectively perform the same functions as the substrate 110, the first layer 120, the second layer 130, and the optical coupling wire 140 described with reference to FIG. 1.

A first optical coupling wire 241 is formed to come into close contact with a first optical port unit 233, which is a preset region on the second layer 230, and a second optical coupling wire 243 is formed to come into close contact with a second optical port unit 235 which is a preset region on the second layer 230. Here, each of the first optical port unit 233 and the second optical port unit 235 may be a grating coupler.

The optical signal input to the optical signal input unit Input2 is transferred through an optical waveguide formed by the substrate 210, the first layer 220, and air, and is distributed and transmitted to the first optical coupling wire 241 and the second optical coupling wire 243 through the first optical port unit 233 and the second optical port unit 235, respectively.

The microscale multi-functional optical structure 200 may serve as an optical distributor which divides and distribute an intensity of the optical signal input to the optical signal input unit Input2 according to detailed structures of the first optical port unit 233 and the second optical port unit 235. Further, when a predetermined optical signal which is the sum of optical signals having two different wavelengths is input to the optical signal input unit Input2, the optical signal having each wavelength component from the input optical signal may be divided and then extracted to each of the first optical port unit 233 and the second optical port unit 235, and each of the first optical coupling wire 241 and the second optical coupling wire 243 respectively connected to the first optical port unit 233 and the second optical port unit 235.

FIG. 2 illustrates that the first optical coupling wire 241 and the second optical coupling wire 243 perform a role of helping the optical signal to be output to the outside of the micro scale multi-functional optical structure 200 by coming into close contact with the first optical port unit 233 and the second optical port unit 235, respectively. However, the first optical coupling wire 241 and the second optical coupling wire 243 may also serve as optical signal input units which help the optical signal to be input from the outside of the microscale multi-functional optical structure 200 to the inside of the microscale multi-functional optical structure 200 by coming into close contact with the first optical port unit 233 and the second optical port unit 235, respectively.

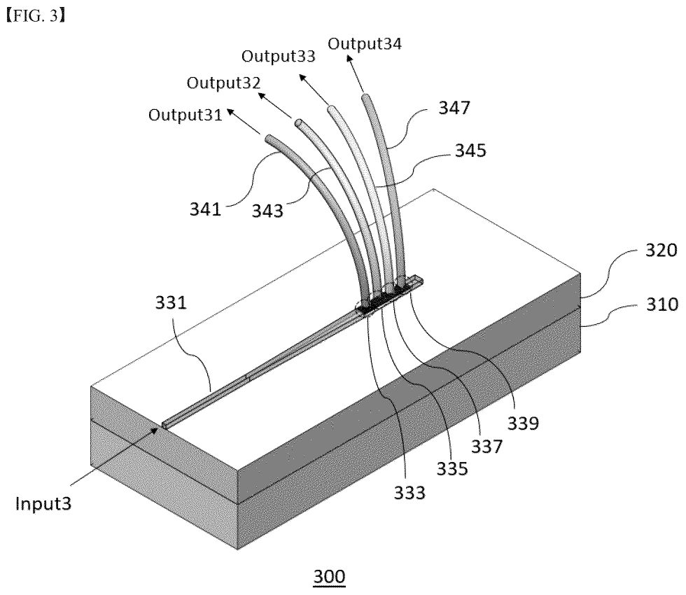

FIG. 3 illustrates a microscale multi-functional optical structure which performs a wavelength division function according to one embodiment of the present disclosure.

Referring to FIG. 3, a microscale multi-functional optical structure 300 according to one embodiment of the present disclosure includes a substrate 310, a first layer 320, a second layer 330, and at least one optical coupling wire 341, 343, 345, or 347.

Here, the substrate 310, the first layer 320, the second layer 330, and the at least one optical coupling wire 341, 343, 345, or 347 respectively perform the same functions as the substrate 110, the first layer 120, the second layer 130, and the optical coupling wire 140 described with reference to FIG. 1.

The microscale multi-functional optical structure 300 is designed so that an optical signal input to an input unit Input3 of the microscale multi-functional optical structure 300 is output to an output unit Output31, Output32, Output33, or Output34 according to a predetermined condition by combining the substrate 310, the first layer 320, the second layer 330 and the at least one optical coupling wire 341, 343, 345, or 347 which are formed to have materials different from each other or at least one material different from each other. Here, the microscale multi-functional optical structure 300 may be a wavelength divider.

For a function as the wavelength divider which receives optical signals having four different wavelengths to divide and output a wavelength component, the microscale multi-functional optical structure 300 includes the substrate 310, the first layer 320, the second layer 330, a first optical coupling wire 341, a second optical coupling wire 343, a third optical coupling wire 345, and a fourth optical coupling wire 347.

The first optical coupling wire 341, the second optical coupling wire 343, the third optical coupling wire 345, and the fourth optical coupling wire 347 are formed to come into close contact with a first optical port unit 333, a second optical port unit 335, a third optical port unit 337, and a fourth optical port unit 339 which are preset regions on the second layer 330, respectively to output optical signals input to the optical signal input unit Input3 to sides Output31, Output32, Output33, and Output34 respectively opposite the first optical coupling wire 341, the second optical coupling wire 343, the third optical coupling wire 345, and the fourth optical coupling wire 347 according to a predetermined condition. Here, when the optical signals input to the optical signal input unit Input3 are optical signals having four different wavelengths, the first optical coupling wire 341, the second optical coupling wire 343, the third optical coupling wire 345, and the fourth optical coupling wire 347 may divide and output the optical signals into a first optical signal, a second optical signal, a third optical signal, and a fourth optical signal which are the optical signals having four different wavelengths. In this case, to this end, grating structures of the first optical port unit 333, the second optical port unit 335, the third optical port unit 337, and the fourth optical port unit 339 are designed to be different from each other, and in order to optimize this, wire end portions of the first optical coupling wire 341, the second optical coupling wire 343, the third optical coupling wire 345, and the fourth optical coupling wire 347 may be individually designed.

FIG. 3 illustrates that first optical coupling wire 341, the second optical coupling wire 343, the third optical coupling wire 345, and the fourth optical coupling wire 347 perform a role of helping the optical signal to be output to the outside of the microscale multi-functional optical structure 300 by coming into close contact with the first optical port unit 333, the second optical port unit 335, the third optical port unit 337, and the fourth optical port unit 339, respectively. However, that first optical coupling wire 341, the second optical coupling wire 343, the third optical coupling wire 345, and the fourth optical coupling wire 347 may also serve as optical signal input units which help the optical signal to be input from the outside of the microscale multi-functional optical structure 300 to the inside of the microscale multi-functional optical structure 300 by coming into close contact with the first optical port unit 333, the second optical port unit 335, the third optical port unit 337, and the fourth optical port unit 339, respectively.

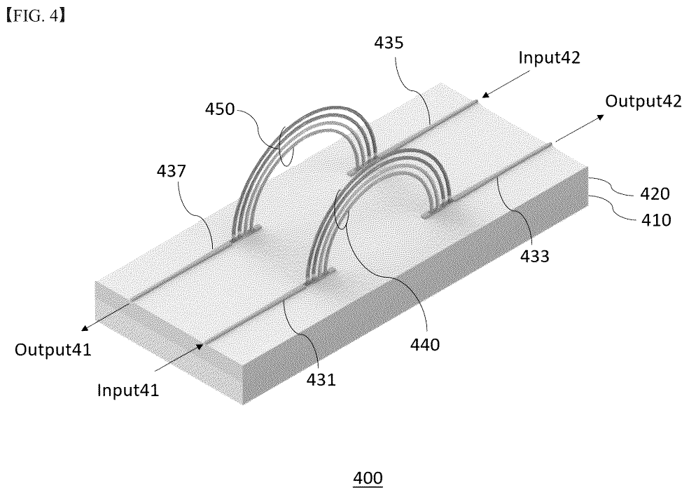

FIG. 4 illustrates a microscale multi-functional optical structure which performs wavelength division and reverse wavelength division functions according to one embodiment of the present disclosure

Referring to FIG. 4, a microscale multi-functional optical structure 400 according to one embodiment of the present disclosure includes a substrate 410, a first layer 420, a second layer 430, and at least one optical coupling wire group 440 or 450.

Here, the substrate 410, the first layer 420, the second layer 430, and the at least one optical coupling wire group 440 or 450 respectively perform the same functions as the substrate 110, the first layer 120, the second layer 130, and the optical coupling wire 140 described with reference to FIG. 1.

FIG. 4 illustrates an example of the multi-functional optical structure 400 usable in an optical transmission and reception module.

A wavelength of an optical signal input through an optical waveguide input unit 431 may be divided and the optical signal may be output by passing through an optical waveguide output unit 433 through an individual optical coupling wire of a first optical coupling wire group 440. Further, a wavelength of an optical signal input through an optical waveguide input unit 435 may be divided and the optical signal may be output by passing through an optical waveguide output unit 437 through an individual optical coupling wire of a second optical coupling wire group 450.

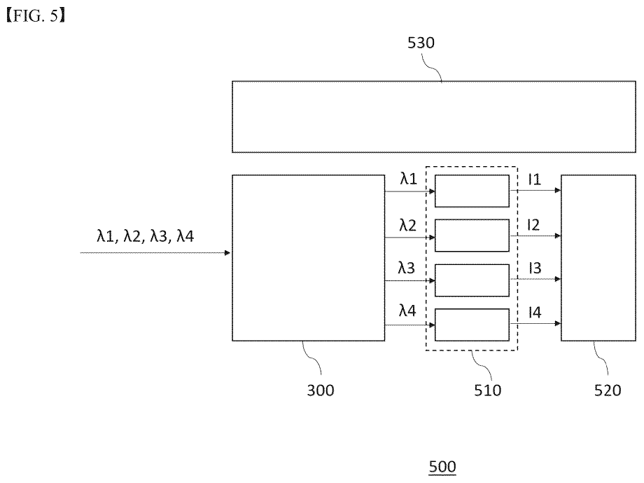

FIG. 5 is a conceptual diagram of an optical module including a microscale multi-functional optical structure according to one embodiment of the present disclosure.

An optical module 500 including the microscale multi-functional optical structure according to one embodiment of the present disclosure includes a microscale multi-functional optical structure 300, a photoelectric conversion element unit 510, an electrical signal amplification unit 520, and a controller 530.

The microscale multi-functional optical structure 300 may be the same as the microscale multi-functional optical structure 300 shown in FIG. 3.

The photoelectric conversion element unit 510 is optically coupled to the multi-functional optical structure 300 to convert an optical signal output from the multi-functional optical structure 300 to an electrical signal. Individual photoelectric conversion elements included in the photoelectric conversion element unit 510 are connected to the multi-functional optical structure 300 through individual optical coupling wires to receive optical signals of different wavelengths.

The electrical signal amplification unit 520 is electrically connected to the photoelectric conversion element unit 510 to change a waveform of the electrical signal received from the photoelectric conversion element unit 510.

The controller 530 is electrically connected to at least one of the multi-functional optical structure 300, the photoelectric conversion element unit 510, and the electrical signal amplification unit 520 to control a function of at least one of the multi-functional optical structure 300, the photoelectric conversion element unit 510, and the electrical signal amplification unit 520.

### EXPLANATION OF NUMBER

100, 200, 300, 400: microscale multi-functional optical structure
110, 210, 310, 410: substrate
120, 220, 320, 420; first layer
130, 230, 330, 430: second layer
133, 233, 235, 333, 335, 337, 339: optical port
140, 241, 243, 341, 343, 345, 347, 440, 450: optical coupling wire
231, 331, 431, 433, 435, 437: optical waveguide
500: optical module
510: photoelectric conversion element unit
520: electrical signal amplification unit
530: controller

What is claimed is:

1. A microscale multi-functional optical structure comprising:
a substrate;
a first layer formed on the substrate;
a multi-functional optical function unit formed using a second layer formed on the first layer to provide various optical functions with the substrate and the first layer; and
at least one optical coupling wire formed to include a wire end portion formed to come into close contact with a preset region on the second layer to transmit and receive an optical signal to and from an optical waveguide.

2. The microscale multi-functional optical structure of claim 1, wherein the multi-functional optical function unit is designed to have a preset shape to provide a function of the optical waveguide with the substrate and the first layer, and formed by including at least one optical signal input unit and at least one optical signal output unit.

3. The microscale multi-functional optical structure of claim 2, wherein at least one of the at least one optical signal input unit and the at least one optical signal output unit includes a grating coupler, and the grating coupler is formed without interruption to come into close contact with the optical coupling wire and provides an optical path between the optical signal input unit and the optical signal output unit.

4. The microscale multi-functional optical structure of claim 3, wherein the at least one optical coupling wire includes a first optical coupling wire and a second optical coupling wire, the first optical coupling wire is formed to come into close contact with a first optical port unit which is a preset region on the second layer, and the second optical coupling wire is formed to come into close contact with a second optical port unit which is a preset region on the second layer, and thus the at least one optical coupling wire is designed so that an optical signal input to the optical signal input unit is distributed and transmitted to each of the first optical coupling wire and the second optical coupling wire according to preset conditions.

5. The microscale multi-functional optical structure of claim 1, wherein the at least one optical coupling wire includes a first optical coupling wire, a second optical coupling wire, a third optical coupling wire, and a fourth optical coupling wire, the first optical coupling wire, the second optical coupling wire, the third optical coupling wire, and the fourth optical coupling wire are formed to come into close contact with a first optical port unit, a second optical port unit, a third optical port unit, and a fourth optical port unit which are preset regions on the second layer, respectively, and thus the at least one optical coupling wire is designed so that an optical signal input to the optical signal input unit is distributed and transmitted to each the first optical coupling wire, the second optical coupling wire, the third optical coupling wire, and the fourth optical coupling wire according to preset conditions.

6. An optical module comprising:
a multi-functional optical structure including a substrate, a first layer formed on the substrate, a multi-functional optical function unit formed using a second layer formed on the first layer to provide various optical functions with the substrate and the first layer, and at least one optical coupling wire formed to include a wire end portion formed to come into close contact with a preset region on the second layer to transmit and receive an optical signal to and from an optical waveguide;
a photoelectric conversion element unit optically coupled to the multi-functional optical structure to convert the optical signal output from the multi-functional optical structure to an electrical signal;
an electrical signal amplification unit electrically connected to the photoelectric conversion element unit to change a waveform of the electrical signal received from the photoelectric conversion element unit; and
a controller electrically connected to at least one of the multi-functional optical structure, the photoelectric conversion element unit, and the electrical signal amplification unit to control a function of the at least one of the multi-functional optical structure, the photoelectric conversion element unit, and the electrical signal amplification unit.
